(19) United States
(12) Patent Application Publication
(10) Pub. No.: US 2014/0151978 A1
(43) Pub. Date: Jun. 5, 2014

(54) Reactive Steering, Instant Center, Twin Linkage System For Use With Tag Trailers For Improved Towability And Safety

(71) Applicant: John T. Whitney, JR., Blanchester, OH (US)

(72) Inventor: John T. Whitney, JR., Blanchester, OH (US)

(21) Appl. No.: 14/097,946

(22) Filed: Dec. 5, 2013

Related U.S. Application Data
(60) Provisional application No. 61/733,629, filed on Dec. 5, 2012.

(51) Int. Cl. B60D 1/173

(52) U.S. Cl. CPC B60D 1/173
USPC 280/458

(57) ABSTRACT

An apparatus for coupling a tag trailer to a towing vehicle includes first and second elongate linkages each having respective first and second ends. The first ends are coupled with respective coupling structures on the towing vehicle, and the second ends are pivotally coupled with a tow support at respective first and second positions such that the first and second linkages are angled with respect to one another to define an instant center of rotation between the towing vehicle and the trailer at a location spaced from the first and second coupling structures on the trailer.

### CROSS-REFERENCE

This application claims the benefit of U.S. Provisional Patent Application Ser. No. 61/733,629, filed Dec. 5, 2012 (pending), the disclosure of which is incorporated by reference herein in its entirety.

### TECHNICAL FIELD

This application relates generally to apparatus for towing vehicles, and more particularly to an improved apparatus for towing tag trailers.

### BACKGROUND

Tag trailers (trailers that are hitched to the rear of a towing vehicle, such as at the rear bumper) are conventionally coupled to a towing vehicle using fixed position tongue hitches. Fixed position tongue hitches incorporate a single attachment coupling device that carries a minimal percent of the total gross trailer weight while towing 100 percent of the gross trailer weight. Fixed position tongue hitches pivot to allow angular misalignment between the towing vehicle and the trailer as the combination travels around corners, over hills and valleys, and along twisting terrains. Fixed position tongue hitches also control the steering of the trailers, and accommodate angular misalignment when attaching the towing vehicle to the trailer.

One drawback of fixed position tongue hitches is that the fixed position tongues cause the tag trailers to drift to the inside of a turn. As used herein, “drift” refers to the tracking of the trailer toward the center of the turn, as compared to following the track of the towing vehicle. In many instances, the trailer may drift outside of the traffic lane, possibly over a curb and sidewalk, thus requiring the towing vehicle to travel outside of its travel lane to accommodate the trailer around the turn. Therefore, fixed position hitches require more room for travel than is often safely available within the travel lane.

### SUMMARY

An apparatus in accordance with the principles of the present invention may be used with tag trailers to provide improved towability of the trailer in terms of improved tracking closely or within the tracks of the towing vehicle when maneuvering around curves and corners, and improved safety for this vehicle combination. An apparatus in accordance with the principles of the present invention is intended to be used with trailers that are attached via a hitch to the rear of a towing vehicle, in contrast with trailers that are attached to the towing vehicle via a fifth-wheel or other hitch located above the rear axle of the towing vehicle.

### BRIEF DESCRIPTION OF DRAWINGS

FIG. 1 is a schematic illustration showing how the wheels of a towing vehicle move around the center point of a turn. This figure depicts a typical vehicle with steerable front wheels and non-steerable rear wheels. As shown in FIG. 1, the rotational axis of each wheel must intersect with the center point of the turn to prevent tire scrubbing. Tire scrubbing generally refers to lateral movement of a tire at the contact patch when the wheels facing the inside of the turn and the wheels facing the outside of the turn do not align with the radius of the turn, such as when they are constrained by their mounting to an axle to remain in alignment with each other rather than the radius of the turn.

FIG. 2 illustrates how a trailer attached to the rear of the towing vehicle will track when being towed around the same turn as the towing vehicle illustrated in FIG. 1. The centerline of the axle and thus the centerline of a two wheel trailer must also intersect with the center point of the turn.

FIG. 3 illustrates how a trailer with multiple axles will track when being towed around the same turn as depicted in FIG. 1. For a trailer with more than one axle, a centerline equally spaced between the front axle and the rear axle of the trailer will pass through the turn center point. This assumes that all wheels of the trailer are loaded equally.

FIG. 4A is a schematic illustration depicting a top plan view of an exemplary apparatus for coupling a tag trailer to a towing vehicle in accordance with the principles of the present invention.

FIG. 4B is a schematic illustration depicting a top plan view of the apparatus of FIG. 4A in a configuration during a turn.

FIG. 5 is a schematic illustration depicting a top plan view of a towing vehicle with a trailer coupled to the vehicle using an apparatus of the present invention, wherein the instant center between the towing vehicle and the trailer is located equidistant between axles of the towing vehicle and trailer.

FIG. 6 is a schematic illustration of the apparatus of FIG. 4A depicting the instant center at the point where linkages of the apparatus cross.

FIG. 7 is a schematic illustration depicting a top plan view of an exemplary apparatus for coupling a tag trailer to a towing vehicle in accordance with the principles of the present invention, wherein linkages of the apparatus do not cross and the instant center is located well beyond the linkages.

FIG. 8 is a schematic illustration depicting a top plan view of a trailer coupled to a towing vehicle with an apparatus in accordance with the principles of the present invention wherein linkages are crossed.

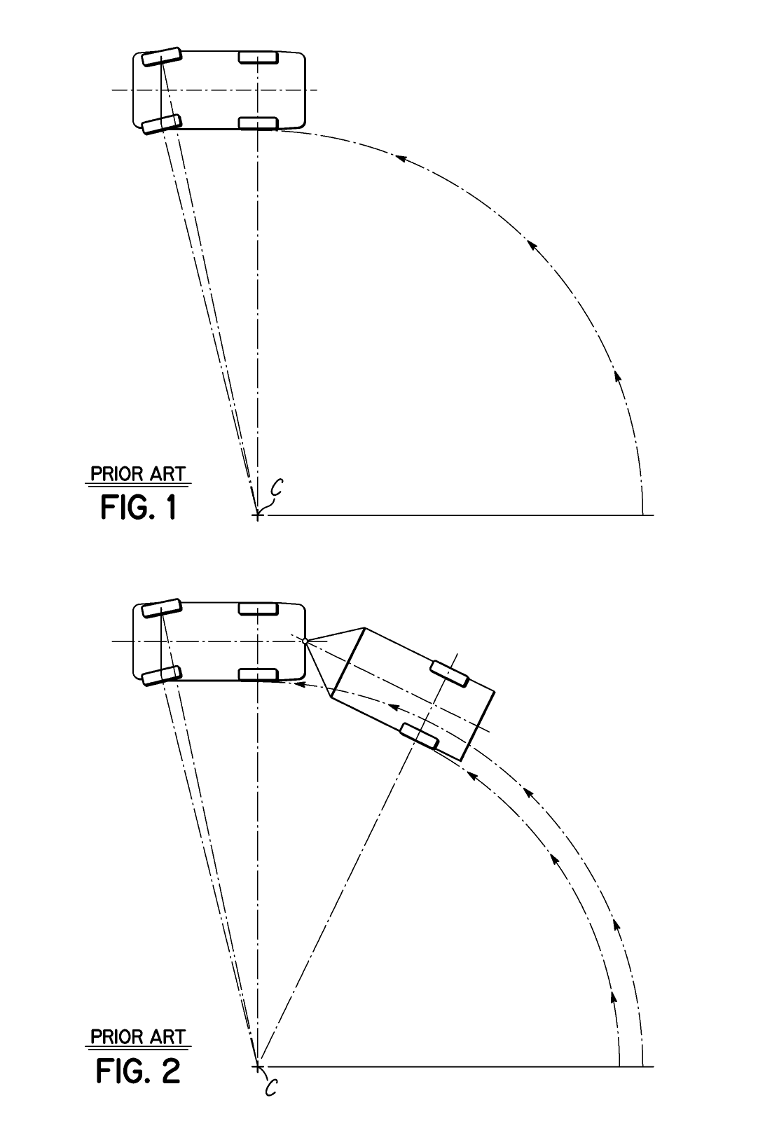

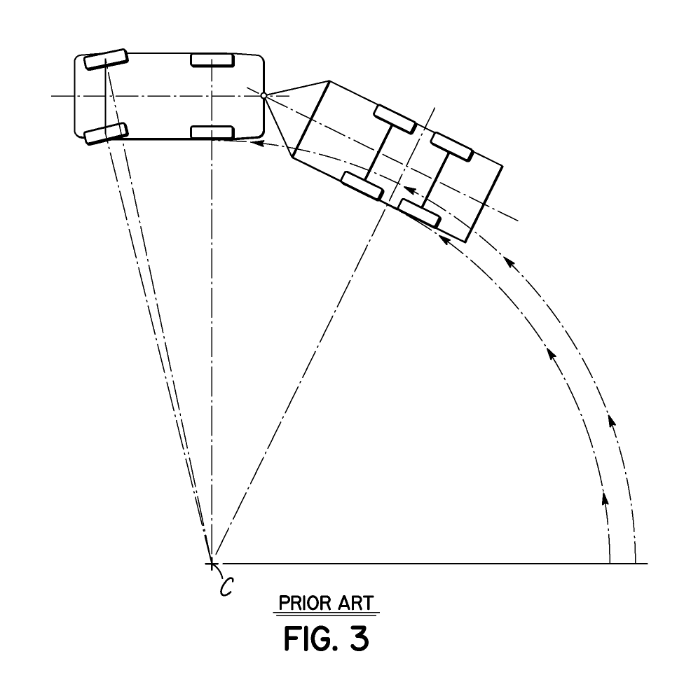

### DETAILED DESCRIPTION

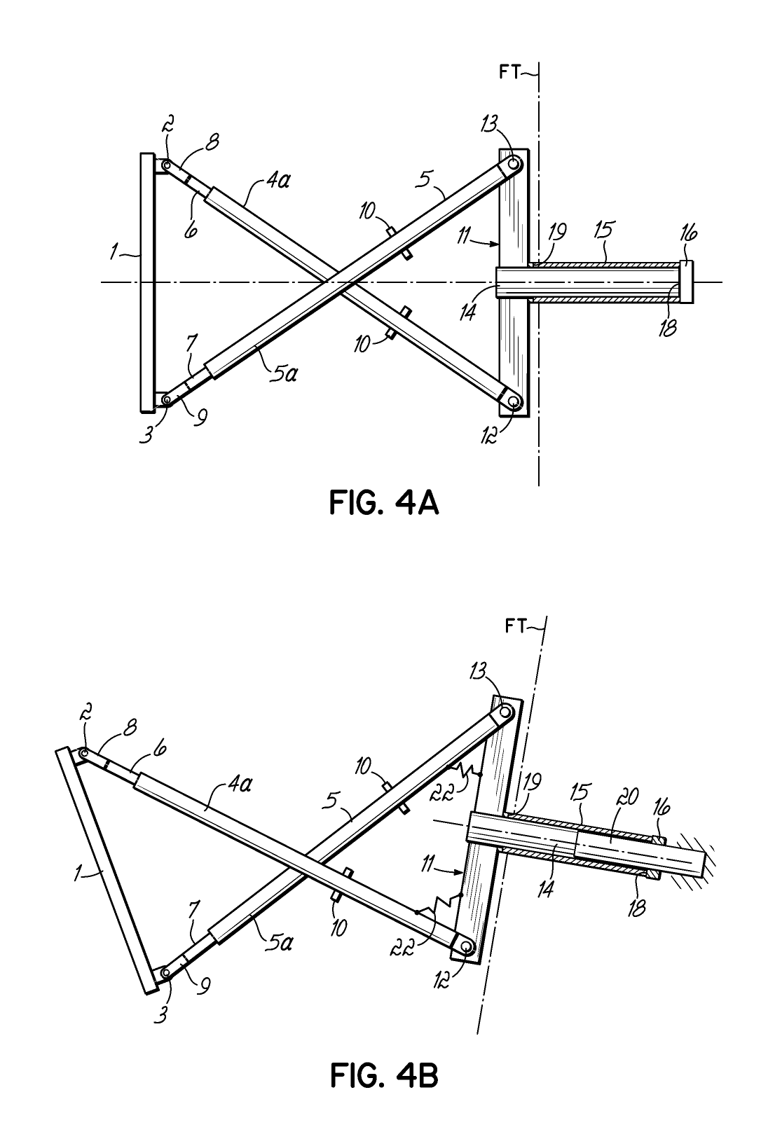

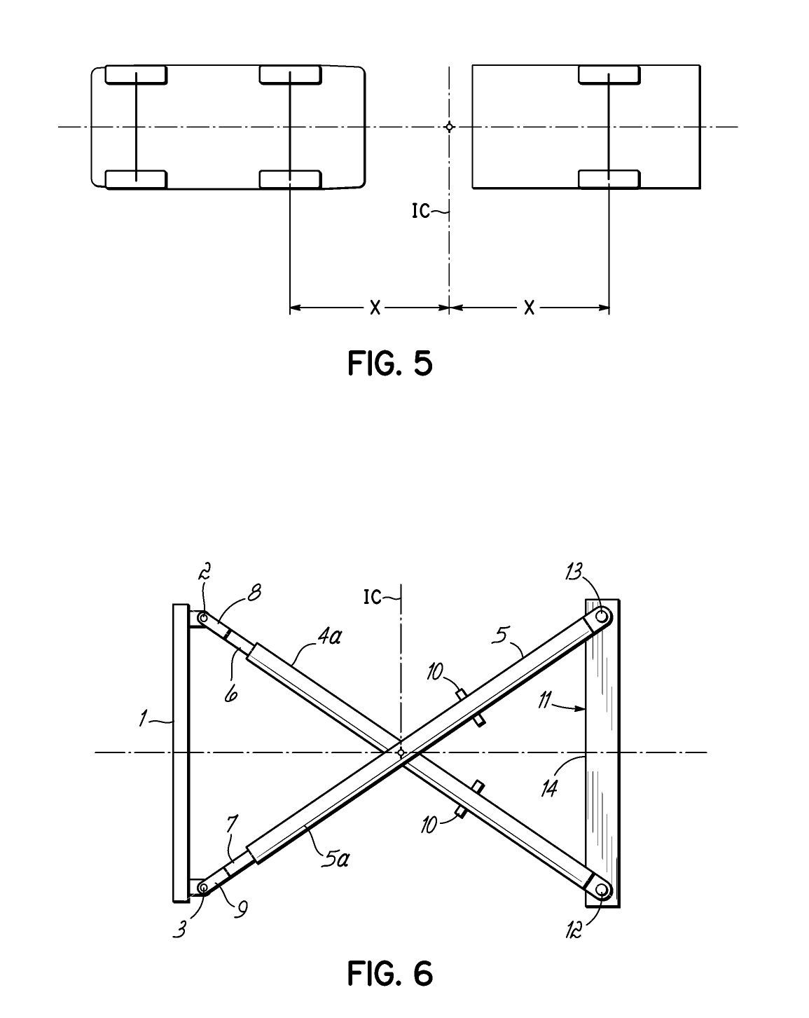

Referring to FIG. 4A, an exemplary apparatus in accordance with the principles of the present invention includes a hitch 1 attached to the rear of the towing vehicle. The hitch 1 may include two male halves (typically balls) of couplers 2, 3 spaced apart from one another. Hitch 1 is generally attached to the back of the towing vehicle to provide structural strength. Hitch 1 may be permanently attached to the towing vehicle, or may be removably attached to the towing vehicle.

The apparatus further includes first and second linkages 4, 5 operatively coupled with the trailer. The linkages 4, 5 may include first and second linkage members that are selectively slidably adjustable relative to one another so that the lengths of the linkages 4, 5 may be selectively adjusted. In the embodiment shown, first linkage 4 includes a sleeve 4a having an inner diameter, and an elongate rod 6 slidably received within the inner diameter. Likewise, second linkage 5 includes a sleeve 5a having an inner diameter, and an elongate rod 7 slidably received within the inner diameter. The position of the rods 6, 7 within the sleeves 4a, 5a are held in place with pins 10. The sleeves 4a, 5a and rods 6, 7 may have generally square cross-sectional shapes to resist rotation of the rods 6, 7 within the respective sleeves 4a, 5a and to control torque transfer between the sleeves 4a, 5a and rods 6, 7. It will be appreciated, however, that sleeves 4a, 5a and rods, 6, 7 may alternatively be constructed in various other configurations, and rotation and torque transfer between the sleeves 4a, 5a and rods 6, 7 may be controlled in various other ways.

In the embodiment shown, rod 6 includes a female coupler 8 adapted to attach to male coupler 2 on the towing vehicle hitch. Likewise rod 7 includes a female coupler 9 adapted to attach to male coupler 3 on the towing vehicle hitch.

The apparatus further includes a tow support 11 provided on the trailer. In the embodiment shown, linkage 4 is coupled with tow support 11 via pin 12 which allows linkage 4 to swing laterally. Linkage 5 is coupled with tow support 11 via pin 13 which allows linkage 5 to swing laterally. In the embodiment shown, tow support 11 includes a shaft 14 which is held in place by a tube 15 attached to the trailer. A retainer 16 is coupled with the back of shaft 14 and captures shaft 14 inside of tube 15 while allowing shaft 14 to rotate within tube 15. On the rear of tube 15 and the front of retainer 16 is thrust surface 18 that bears the forward thrust of the trailer. On the rear of tow support 11 and the front of tube 15 is a thrust surface 19 that bears the stopping thrust of the trailer.

The apparatus may further include a torsion bar 20 located inside of and coupled with shaft 14. A distal end of torsion bar 20 may extend beyond retainer 16 and is attached to the trailer. Torsion bar 20 constrains rotational movement of shaft 14 within tube 15. The apparatus may further include biasing members 22, such as springs, coupled with linkages 4, 5 proximate pins 12 and 13, respectively, and pivotally biasing linkages 4, 5 in directions toward one another when the female couplers 8, 9 are disengaged from the respective male couplers 2, 3. In one embodiment, the biasing members 22 may be torsions springs, however, various other biasing members may alternatively be used.

### Operational Description

The dynamics of towing vehicle and trailer combinations are best described as having an instant center where the angular intersection of linkage centerlines between the towing vehicle and the trailer takes place.

The instant center of the hitch system for a fixed position tongue system coupled to the rear of the towing vehicle is located in the center of the coupling that attaches the two together. This instant center typically results in an unequal distance from the towing vehicle as compared to the trailer; that is from the rear axle of the towing vehicle to the instant center (center of the coupling) and from the instant center (center of coupling) to the effective center of the trailer axle(s). It is this unequal distance to the instant center that results in drift when towing the trailer around corners.

The apparatus in accordance with the principles of the present invention provides a reactive-steering, instant center twin-linkage trailer system that controls the drift of a trailer by providing an optimum or improved instant center between the towing vehicle and the trailer. The two linkages 4 and 5 are installed in a non-parallel arrangement between the towing vehicle and the trailer. Being non-parallel, the two centerlines of the linkages 4, 5 will intersect at some point. Where the two centerlines intersect will be the instant center of the system.

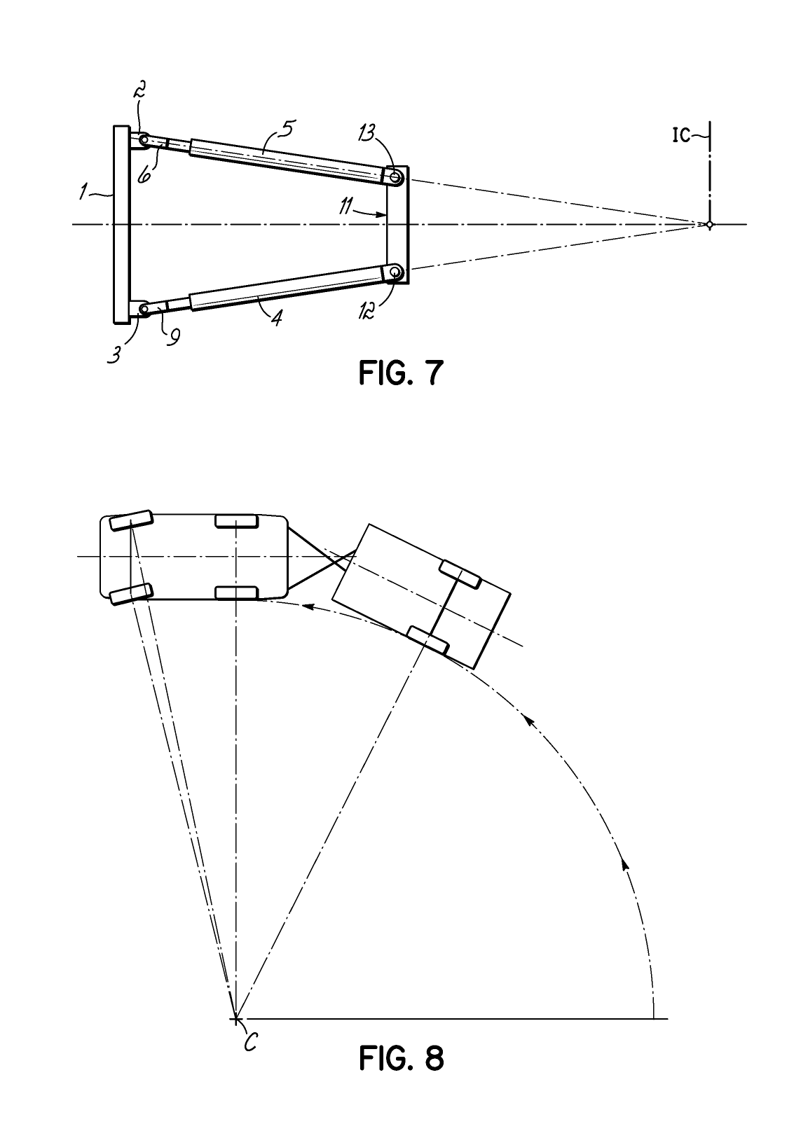

The two linkages 4, 5 can be arranged so the instant center is located within the length the linkages by having them cross over one another in an X arrangement, or the instant center can project beyond the end of the linkages when the linkages do not cross each other. As seen in FIG. 6 the instant center of crossed linkages 4, 5 will be moved toward the ends that are attached closer together. This can be affected by modifying either or both the distance between couplings 2, 3 and/or pins 12, 13. As seen in FIG. 7 the instant center of uncrossed linkages 4, 5 will project beyond the ends that are attached closer together. This also can be affected by modifying either or both the distance between couplings 2, 3 and/or pins 12, 13. When projecting the instant center, it can be projected forward toward the towing vehicle, or rearward toward the trailer as may be desired.

The reactive steering instant center twin linkage trailer system provides load carrying capability, pulling and stopping thrust of the trailer with the twin linkages with thrust surfaces 18 and 19 the same as fixed position tongue hitches.

When the reactive steering instant center twin linkage trailer system travels over twisting terrains shaft 14 may rotate within tube 15 to compensate the system, while angular compensation over hills and valleys is accomplished with couplers 8 and 9.

When a towing vehicle with a reactive steering instant center twin linkage trailer system as disclosed herein begins to turn, the system will react to steer the trailer into a preferred path behind the towing vehicle. The linkage that is attached to the coupler 2 or 3 which is on the side nearest the center point of the turn, acts as the steering linkage and pushes the trailer into a wider preferred arc. The linkage attached to the coupler 2 or 3 which is attached the towing vehicle on the side farthest away from the center point of the turn, acts as the linkage doing most of the work that moves the trailer forwards or backwards.

When the linkages 4, 5 are uncoupled from a tow vehicle and are not positioned equally from the centerline of shaft 14, the linkage that is farthest away from the centerline may cause a torque to develop that acts on tow support 11 carried on shaft 14, as a result of gravitational forces. Such a torque may cause the tow support 11 to rotate about the centerline of shaft 14. Torsion bar 20 reacts against the rotation of tow support 11 to counteract any such rotation of tow support 11. Moreover, biasing members 22 facilitate keeping linkages 4, 5 close to being equally positioned about the centerline of shaft 14, thereby maintaining equal gravitational effect on tow support 11 by linkages 4, 5.

Since a reactive steering instant center twin linkage trailer system requires attachment to the towing vehicle with two couplers 8 and 9 at couplers 2 and 3, alignment of the towing vehicle with the trailer is needed when attaching the trailer. To facilitate attachment, the linkages 4, 5 may have inner sleeves 4a, 5a and 7 with rods 6, 7. By removing pins 10, the rods 6, 7 can be telescoped outwardly and couplers 8 and 9 can be moved laterally to achieve alignment with and attachment to the male couplers 2, 3 on the towing vehicle. As the towing vehicle is moved closer to the trailer, the trailer will center itself, then pins 10 may be re-installed for towing.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. Apparatus for coupling a tag trailer to a towing vehicle having first and second spaced apart coupling structures for joining the trailer to the towing vehicle, the apparatus comprising:
a first elongate linkage having first and second terminal ends;
a second elongate linkage having first and second terminal ends;
the first ends of the first and second linkages each including a coupling complementary to and engagable with the respective first and second coupling structure on the towing vehicle; and
a tow support configured to be secured to the trailer;
the second end of the first linkage pivotally coupled with the tow support at a first position, and the second linkage pivotally coupled with the tow support at a second position spaced from the first position such that the first and second linkages are angled with respect to one another to thereby define an instant center of rotation between the towing vehicle and the trailer at a location spaced from the first and second coupling structures on the towing vehicle.

2. The apparatus of claim 1, wherein the first and second linkages each comprise:
a first linkage member; and
a second linkage member selectively slidably adjustable relative to the first linkage member;
the first linkage member defining one of the first or second terminal ends, and the second linkage member defining the other of the first and second terminal ends.

3. The apparatus of claim 2, wherein one of the first or second linkage members is a sleeve having an inner diameter, and the other of the first or second linkage members is an elongate rod slidably received within the inner diameter of the sleeve.

4. The apparatus of claim 3, further comprising a locking member cooperating with the first and second linkage members, the locking member selectively engagable to fix the position of the rod slidably received within the sleeve to thereby adjust a length of the linkage.

5. The apparatus of claim 1, wherein the first and second positions where the second ends of the linkages are coupled with the tow support are spaced apart a distance such that the first and second linkages cross over one another when the first and second linkages are coupled with the respective first and second coupling structures on the towing vehicle.

6. The apparatus of claim 1, wherein the first and second positions where the second ends of the linkages are coupled with the tow support are spaced apart a distance such that the first and second linkages do not cross over one another when the first and second linkages are coupled with the respective first and second coupling structures on the towing vehicle.

7. The apparatus of claim 1, wherein the tow support comprises:
an elongate member having first and second ends spaced longitudinally apart, the first position on the tow support located proximate the first end, and the second position on the tow support located proximate the second end.

8. The apparatus of claim 1, wherein the tow support comprises an attachment for pivotally coupling the tow support to the trailer for rotation about an axis extending in a direction from the trailer toward the towed vehicle.

9. The apparatus of claim 8, wherein the attachment comprises:
an elongate shaft extending from the elongate member; and
a tube defining an interior bearing surface sized to receive the shaft therein such that the shaft is rotatable with respect to the tube about a longitudinal axis of the shaft.

10. The apparatus of claim 9, further comprising:
a torsion bar coupled with the shaft and the trailer, the torsion bar biasing the shaft against rotation with respect to the tube.

11. The apparatus of claim 10, further comprising a torsion spring proximate the second of each of the first and second linkages, the torsion springs biasing the first and second linkages in directions toward the longitudinal axis of the shaft.

12. A method of securing a tag trailer to a towing vehicle, the method comprising:
coupling a first end of a first linkage to a first coupling structure on the towing vehicle for pivotal movement relative to the first coupling structure;
coupling a first end of a second linkage to a second coupling structure on the towing vehicle for pivotal movement relative to the second coupling structure, the second coupling structure spaced apart from the first coupling structure;
coupling a second end of the first linkage to a first position on the trailer for pivotal movement relative to the first position; and
coupling a second end of the second linkage to a second position on the trailer for pivotal movement relative to the second position;
the second position on the trailer spaced apart from the first position on the trailer such that the first and second linkages are angled with respect to one another to thereby define an instant center of rotation between the towing vehicle and the trailer at a location spaced from the first and second coupling structures.

13. The method of claim 12, wherein the first and second positions on the trailer are defined by a tow support coupled with the trailer.

14. The method of claim 12, wherein coupling the second ends of the first and second linkages to the first and second positions results in an arrangement wherein one of the first or second linkages crosses over the other of the first or second linkages.

15. The method of claim 12, wherein coupling the second ends of the first and second linkages to the first and second positions results in an arrangement wherein the first or second linkages do nor cross over one another.

16. The method of claim 12, further comprising:
adjusting a length of at least one of the first or second linkages to facilitate coupling the linkage to the respective coupling structure on the towing vehicle.
